(19) United States
(12) Patent Application Publication
(10) Pub. No.: US 2008/0085700 A1
(43) Pub. Date: Apr. 10, 2008

(54) Event update management system

(76) Inventor: Varun Arora, Singapore (SG)

Correspondence Address: ARORA, Varun, 9 International Business Park, Singapore, 609915, SG

(21) Appl. No.: 11/905,174

(22) Filed: Sep. 27, 2007

(30) Foreign Application Priority Data
Sep. 29, 2006 (SG) 200607001-5

(51) Int. Cl. H04M 3/42; H04M 3/493; H04Q 7/22

(52) U.S. Cl. 455/414.3

(57) ABSTRACT

The growth and expansion of the Internet has encouraged companies as well as consumers to use the Internet for all kinds of purpose ranging from advertising to e-commerce to online shopping to blogging and news dissemination. The Internet is currently the fastest media to spread information. With the advent of the wireless age and proliferation of mobile devices, the Internet is projected to grow even more especially in the mobile wireless application arena. Increasingly, it is becoming a mammoth task for end-users to keep track of new events and updates on the Internet. Current event update management systems that allow mobile service users to keep track of updates from websites of their interest suffer from various inflexibilities and disadvantages. A disclosed embodiment of the disclosure describes a system and a method to address the problems faced by existing event update management systems.

This application claims priority under 35 U.S.C. 119 to SG 200607001-5, filed Sep. 29, 2006.

### FIELD OF THE DISCLOSURE

The present disclosure relates to a system and a method for managing website updates. In particular, the present disclosure relates to a system and a method for subscribing to and sending updates and notifications with regards to new or changed content of websites to mobile service users.

### BACKGROUND OF THE DISCLOSURE

Rapid advances in Internet technologies and the subsequent proliferation of economic activities on the Internet have led to the phenomenal growth of the Internet, ushering in a digital information age. The Internet is now the fastest way to spread information to large groups of people simultaneously. The number of web users has also more than doubled since the year 2000, and as of 2006, there are over 1.02 billion Internet users according to Internet World Stats. There is plenty of room for expansion, and much of this growth will occur using wireless applications to access the Internet. Mobile and wireless devices have proliferated the market on a large scale. According to market research firm Garter, global handset sales hit 205 million in 2005. Presently, there are an estimated 1.5 billion Global System for Mobile Communications (GSM) users globally with this figure projected to rise to 3 billion in 2010. In addition, the latest figures show that the global shipments of smart mobile devices rose 55% in 2006, with smart phone shipments increasing by 75% compared to one year ago, highlighting a shift from handhelds to converged devices.

The Internet itself has already been transformed into a large marketing ground for many companies. Some of the biggest companies have grown by taking advantage of the efficient nature of low-cost advertising and by conducting e-commerce through the Internet. The Internet has also challenged and revolutionized traditional shopping and news dissemination concepts. Additionally, the rise of online communities such as blogs and social networks are further poised to shape the Internet's future. Thus, due to the sheer volume and amount of information available online, keeping track of new events and updates on the Internet is gradually becoming a mammoth task for web users.

Presently, there are already systems that would allow web users to keep track of available updates to websites they are interested in. The technology used by these systems is termed “push alert” since update snippets are pushed out whenever updates are available. Push alert systems therefore allows trusted application servers to proactively send personalized content to web users. Push alert systems complement the traditional “pull” model of the Internet where web users request specific information from websites. To receive updates from websites the web users are interested in, they must first subscribe for alert updates from the websites. This process is equivalent to registering as mailing receipts on a mailing list. Normally, information such as a username, an email-address or a mobile phone number are supplied by the Internet users through alert registration forms provided by the websites. The collected information is then recorded in a database hosted on a backend server, which is normally managed and operated by a website manager.

A general problem with current push alert systems is that the website manager physically maintains the database for ensuring the accuracy of the user information. Hence for large databases, the required maintenance work to be carried out is enormous and laborious. Although these push alert systems are manageable by large organizations, the cost and complexity make push alert systems unviable for smaller site operators, individual blog publishers and the like. Further, current push alert systems often require costly database servers. Additionally, current push alert systems are mainly applicable for sending updates to only email addresses.

With the proliferation of mobile devices, and their “always on, always with the user” characteristics, increasingly more web users may prefer to be alerted via their mobile devices. Alerts on, for example information on upcoming television programme, is preferably sent to the user's mobile device about 15-30 minutes prior to the airing of the programme. The mobile device is likely to always be with the user and turned on as compared to emails, which are often not read at the appropriate time. There are other applications for mobile alerts such as auction out-bid alerts, meeting reminders, and more. Such alerts are preferably sent via Short Message Service (SMS) messages, Multimedia Messaging Service (MMS) messages, or Wireless Application Protocol (WAP) Push messages. Despite the obvious advantages of using mobile alerts, there are a number of reasons why mobile alerts are not as widely implemented by website managers as the almost ubiquitous email alerts.

A general problem with implementing mobile alerts is the cumulatively high cost of sending the mobile alerts. In general, to send a mobile alert, the sender of the mobile alert must either be a subscriber of a mobile services provider and possess the relevant technical equipment required to send the mobile alert or must have some other means of delivering the message through the mobile services provider's network to the recipients. In either case, there are unrecoverable costs involved for the sender. Sending mobile alerts may cost the sender an appreciable amount with no clear revenue possibilities. For example, there is no clear incentive for operators such as free-to-air advertising-supported television stations, providers of free Web-based email service or individual blog publishers to notify their subscribers of programme showings, new emails or blog updates via mobile alerts.

A work-around alternative applicable only for very select conditions exist as a receiver-pays model where the recipient of the message pays a significant premium charge to receive the message while the sender is not charged. Mobile phone content providers dealing with, for example mobile handset ring-tones or mobile handset wallpapers, generally adopt the receiver-pays business model. The mobile phone user is charged for the mobile content in his monthly mobile bill, with the proceeds being shared between the mobile services providers and the mobile phone content providers. Accordingly, the exact amount to be charged to the mobile phone user and the percentage of the proceeds thereof to be shared between the mobile services providers and the mobile phone content providers is already pre-negotiated through agreements. The agreements require the mobile phone content providers to commit to a certain minimum number of mobile phone messages and require a commitment fee to be paid by the mobile phone content company to the mobile services provider. In addition, the mobile phone content providers are also required to perform custom systems integration work to interconnect their system to the mobile services provider's network. A number of problems exist with the work-around alternative, particularly for low-volume, not-for-profit senders.

One problem is that this model does not apply to low-volume senders since a certain minimum volume of mobile alerts, for example in the tens or hundreds of thousands, must be committed to by the messenger sender. Another problem is that as this model is predicated on charging the recipient a very significant premium and then sharing the proceeds, it is irrelevant to small website owners who are not using the mobile alerts mechanism to sell content. Further for small website owners who want to offer mobile alerts as a not-for-revenue service offering are likely to find the pre-paid commitment fee financial unjustifiable. Yet another problem with this model is that the message sender must integrate his systems with the mobile services provider's messaging systems, involving more time, effort and costs for both the message sender and the mobile services provider. Lastly, this method often falls victim to deceptive and false billing practices by the message sender, and thus negatively impacts the relationship between the mobile services provider and the mobile phone customer.

The aforementioned method is sometimes dependent on the message sender submitting, to the mobile services provider, a list of mobile phone subscriber numbers that are to be charged for the service. This is a consequence of the mobile phone being only the recipient of the content while the content may be requested by the user via a telephone call through other mobile services provider's network or from the sender's website (by the user entering his mobile number directly on the sender's website). Depending on the technology used, the mobile services provider thus cannot easily ascertain the validity of the message sender's claimed recipient list until the recipient receives his mobile phone bill and disputes the relevant charge on the bill. The dispute resolution process that follows then strains the relationship between the mobile services provider and the message recipient who is the end customer.

Yet another problem to all the aforementioned problems is that, in general, the message sender would also need an agreement with each mobile service provider to whose subscribers he wishes to deliver messages. As most mobile services providers have their own messaging systems and legal contracts, separately signing up and interconnecting with each mobile service provider is time consuming, expensive, and impractical for the message sender. To counter this problem, a few organizations provide a service wherein the message sender contracts with one of the organizations and the organization liaise with most mobile service providers and handle the contractual and technical issues. However, these organizations require a fee to be paid per message sent, which tends to be even higher than the message sender would have paid the mobile service provider if the message sender is contracted directly with the mobile service providers. Thus, the use of an intermediary service provider in this manner is also expensive and impractical for the message sender.

Another problem is the lack of clarity to the message recipient with respect to opting out of receiving messages. This is particularly important in the case of subscription services such as, for example, joke-of-the-day services, where the message sender charges the message recipient a premium charge, daily, for sending a daily joke to the recipient's mobile device. As this is not a one-off transaction, there must be a clear way for the message recipient to terminate the service. Yet, it is not in the interest of the message sender to make clear the opt-out mechanism for the recipient to unsubscribe from the service. Further, it is technologically challenging to include detailed opt-out information in a mobile alert, particularly when the mobile alert is being sent via SMS, since an SMS has a 160-character limit within which the content must also be included.

Therefore, the disadvantages of the current systems demonstrate a need for a system and a method for delivering mobile alerts to a recipient without requiring the recipient to pay a significant premium charge for receiving the mobile alerts and preferably not requiring the message sender to pay for sending the mobile alerts while being able to send mobile alerts to subscribers of as many mobile service providers as possible. Additionally, the system and method are preferably easy to use and easy to integrate, making it feasible for end-users with little technical knowledge or ability to send mobile alerts, while at the same time the system and method are preferably scalable and adaptable to meet the needs of large organisations that may want to deliver more complex messages with more complex business rules. Yet another requirement is that the system and the method preferably incorporate validation parameters such as verification of the recipient's request to receive mobile alerts, thus minimising mobile spam, and offer a clear opt-out mechanism, making it easy for the recipient to prevent one or more message senders from sending him mobile alerts.

### SUMMARY OF THE DISCLOSURE

The present embodiment disclosed herein provides an event update management system. In accordance with an aspect of the disclosure, there is disclosed an event update management system comprising a data module, a matching module, a processing module and an alert module. The data module receives alert registration data provided by a web-host server. The alert registration data is generated when a mobile service user submits an alert registration request corresponding to an event through the web-host server. The matching module in turn matches the mobile service user with a pre-defined list containing a plurality of mobile services subscribers. The mobile service user is a mobile services subscriber when matched to one of the plurality of mobile services subscribers. A processing module then processes the alert registration data and records the alert registration data to a database stored on the event update management system. Lastly the alert module generates and sends an alert to the mobile service user in response to an instruction provided by the web-host server or by a website manager operating the web-host server.

### BRIEF DESCRIPTION OF THE DRAWINGS

Embodiments of the disclosure are disclosed hereinafter with reference to the drawings, in which:

FIG. 1 shows a block diagram illustrating the interaction between different system components of an event update management system according to an embodiment of the disclosure;

FIG. 2 shows a graphical format of a service registration form for use by a low volume message sender when signing up with an application service provider for sending mobile alerts for use in conjunction with the event update management system of FIG. 1;

FIG. 3 shows a graphical format of a service registration form for use by a high volume message sender when signing up with the application service provider for sending mobile alerts for use in conjunction with the event update management system of FIG. 1;

FIG. 4 shows a flowchart illustrating a process wherein a website manager signs up with the application service provider for sending mobile alerts using the event update management system of FIG. 1;

FIG. 5 shows a graphical format of an alert registration form for use in conjunction with the event update management system of FIG. 1;

FIG. 6 shows a flowchart illustrating a process wherein a mobile service user registers for mobile alerts using the alert registration form of FIG. 5 for receiving updates of a website using the event update management system of FIG. 1, a website manager operating the website being a low volume message sender;

FIG. 7 shows a flowchart illustrating a process wherein a mobile service user registers for mobile alerts using the alert registration form of FIG. 5 for receiving updates of the website using the event update management system of FIG. 1, the website manager operating the website being a high volume message sender;

FIG. 8 shows a graphical format of an opt-out form for use in conjunction with the event update management system of FIG. 1;

FIG. 9 shows a flowchart illustrating an opt-out process wherein the mobile service user opt-out for receiving mobile alerts using the opt-out form of FIG. 8 via the event update management system of FIG. 1.

### DETAILED DESCRIPTION

An event update management system for providing updates and event notifications to mobile service users who have registered for receiving website updates via mobile alerts, is described hereinafter for addressing the foregoing problems. An embodiment of the disclosure provides a system and a method for enabling website managers to send mobile alerts to mobile service users interested in being alerted when relevant content changes on the website managed by the website managers. The disclosed system and method processes alert registration requests from mobile users as well as alert sending requests from website managers, stores alert registration information, sends the mobile alerts to the mobile service users and bills at least one of the mobile service providers, mobile service users and the website managers for services usage. The disclosed system and method also further allows the website managers to easily and quickly use the system at minimal cost or no cost.

For purposes of brevity and clarity, the description of the disclosure is limited hereinafter for use in systems for providing updates and event notifications to the mobile service users have registered for receiving website updates via mobile alerts. This however does not preclude various embodiments of the disclosure from other applications that require similar operating performance as systems for providing updates and event notifications to mobile service users who have registered for receiving website updates via mobile alerts. The operational and functional principles fundamental to the embodiments of the disclosure are common throughout the various embodiments.

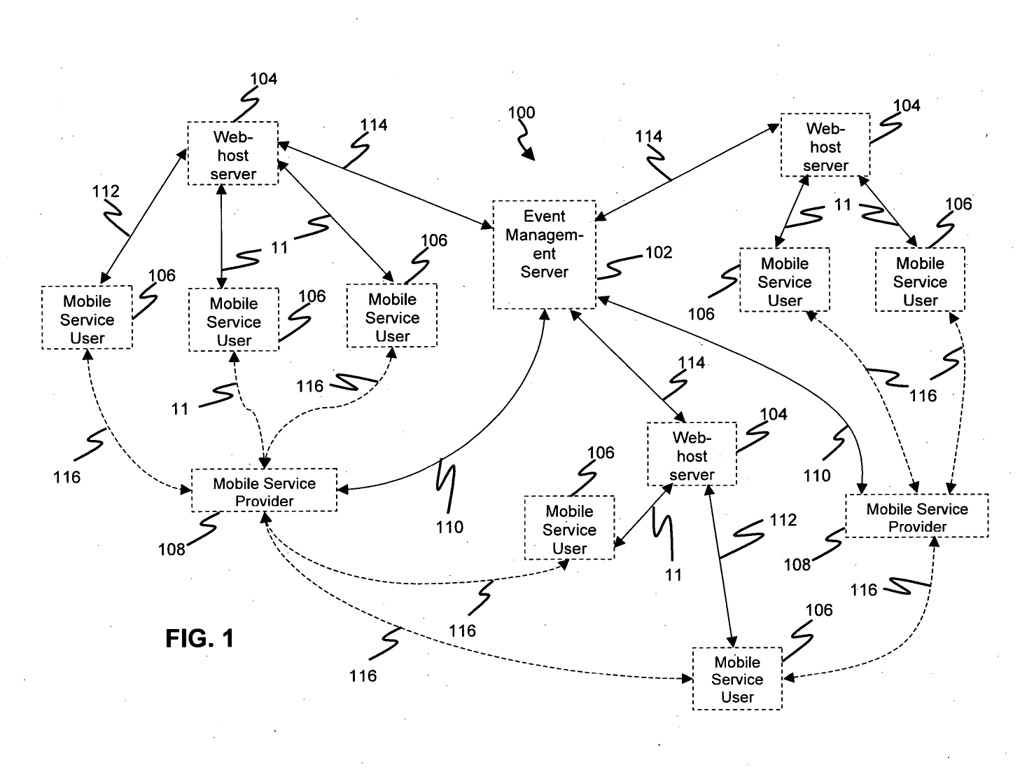

Embodiments of the disclosure described hereinafter are in accordance with FIGS. 1 to 9 of the drawings, in which like elements are numbered with like reference numerals.

With reference to FIG. 1, which shows a block diagram illustrating the interaction between different system components of an event update management system 100, an embodiment of the disclosure is described. The event update management system 100 comprises an event-management server 102, web-host servers 104, mobile service users 106 (hereinafter referred to as mobile users) and mobile service providers 108. The event-management server 102 is preferably located and pre-installed at an application services provider's premises, wherein the application services provider (not shown) operates the event-management server 102 and connects to one or more mobile service providers 108 via a first set of mobile links 110. There may be multiple application service providers running multiple event management servers 102, connected to a plurality of diverse mobile service providers 108 and web-host servers 104 and serving diverse mobile users 106. The mobile users 106 are either subscribers or non-subscribers of the mobile services provided by the mobile services providers 108 with whom the application service provider operating the event-management server 102 is connected or with whom the application service provider operating the event-management server 102 has a contract. Additionally, at least one of the mobile service providers 108 may function as an application service provider. The multiple event management servers 102 also intercommunicate with one another for coordination.

The event-management server 102 processes and records mobile alerts registration information received from the web-host servers 104. The mobile alerts registration information received may then be recorded in a database (not shown) stored on the event-management server 102. Additionally, the event-management server 102 also provides the functions of enabling website managers who wish to send mobile messages to mobile users 106 to sign up for mobile alerts services, provides website managers with tools and/or codes for providing visitors to the websites with the ability to register for mobile alerts, and also further provides website managers with administrative tools for administering their own accounts stored on the event-management system 102. The term “website managers” is used broadly and non-exclusively to refer to either system administrators or users' personal webpages that are hosted by a website for example a website that allows users to post and share pictures or do blogging. The user, in this case, with account privileges to post and share pictures or do blogging is then considered the “website manager” regardless of whether the user possesses administrative rights to servers that are hosting his personal webpages so long the user possesses the right to modify his personal webpages seen by visitors.

The event-management server 102 sends notifications to and receives responses from the mobile users 106, through the mobile service provider 108, via the mobile alerts. The mobile service provider 108 is preferably a mobile service provider 108 of the mobile user 106. This event management server 102 further preferably provides mobile users 106 with the ability to control which website managers may send them how many alerts in any given period, including the ability to temporarily or permanently bar all further alerts from the website managers whose alerts the mobile users 106 may have earlier registered for. The mobile alerts are preferably Short Message Services (SMS) messages, Multimedia Messaging Service (MMS) messages, or Wireless Application Protocol (WAP) push message alerts. Website managers operating the web-host servers 104 are already pre-contracted with the application services provider for using the aforementioned services provided by the event management server 102. Similarly, the application services providers are also already pre-contracted with the mobile service providers 108 in order to deliver mobile alerts, which may be reverse-charging (receiver pays) mobile alerts. The last important function of the event-management server 102 is to bill the mobile users 106, mobile service providers 108 and website managers for the aforementioned services rendered by the event-management server 102.

The web-host servers 104 provide webpages to web-surfers visiting websites (not shown) that are hosted on the web-host servers 104. The mobile users 106 access the webpages hosted on the web-host servers via bidirectional wired or wireless links 112. The webpages served by the websites are heterogeneous and diverse in content. For the web-host servers 104 to communicate with the event-management server 102, the web-host servers 104 must firstly be registered with the event management server 102. The web-host servers 104 communicate with the event-management server 102 via bidirectional links 114 that are either wired or wireless. The web-host servers 104 must also be pre-programmed with software functions defined in a set of software Application Programming Interface (API) structures and be integrated with software libraries. The software libraries are implementations of the functions defined in the set of API structures provided by the application services provider, compiled in binary form. Alternatively, the web-host servers 104 may communicate with the event management server 102 through the simple insertion of a block of Hyper Text Markup Language (HTML) link codes into programming codes defining the websites or through other technical means mutually agreed between the application service provider and the website manager. The application services provider supplies at least one of the set of API structures, the software libraries and the HTML link codes.

The event-management server 102 sends mobile alerts for notifying the mobile users 106 of websites updates through its connections or contracts with the mobile service providers 108 which, in turn, deliver the mobile alerts to the mobile users 106 via a second set of mobile links 116. The mobile alerts are only sent when the website managers log onto the event-management server 102 for instructing that the mobile alerts be sent to the mobile users 106 or when computer-based systems operated by the website managers automatically log on to the event-management server 102 using the APIs and/or HTML codes and/or other technical means provided to the website manager by the application service provider as abovedescribed.

In order for the website manger to send mobile alerts to mobile users 106 who are visitors to the website operated by the website manager and are further interested in receiving the mobile alerts regarding updates of the website, the website manager needs to sign up for the relevant services offered by the application service provider by filling in a service registration form. The website manager can either sign up as a low volume message sender or as a high volume message sender.

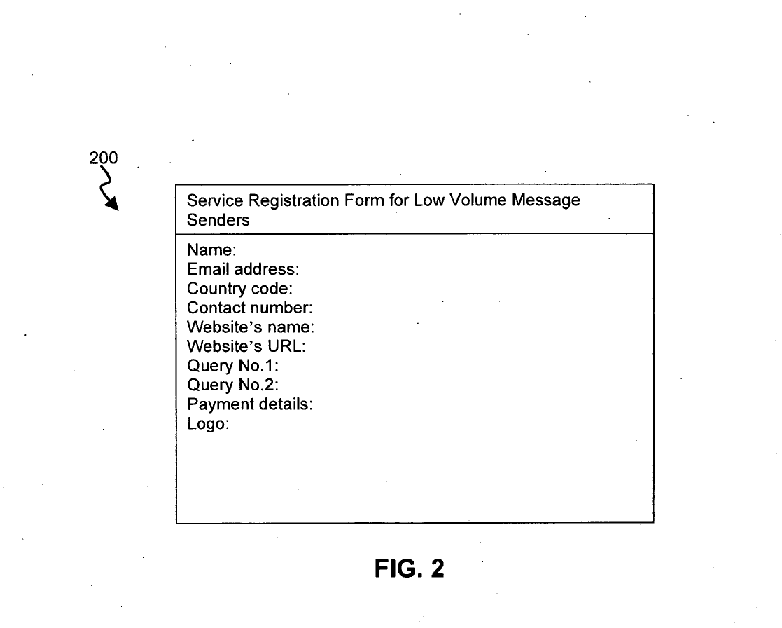

FIG. 2 depicts a service registration form for low volume message senders 200 (hereinafter referred to as low-volume form) in a graphical format defining entry fields of the low-volume form 200. The low-volume form 200 contains the entry fields for defining a website manager's name, a website manager's email address, a website's name, a website's URL, a query No. 1, a query No. 2, payment details, a logo, a country code and a contact number. The country code and the contact number provide a contact point at which the low volume message sender can be reached, either for identity validation, dispute resolution or any other communication. A logo should preferably be submitted under the logo entry field to be attached to a registration form that the mobile user 106 sees when signing up for the mobile alerts service from the website manager, wherein the logo provides the website manager with the ability to customize the registration form.

Additionally under query No. 1, the website manager is required to indicate whether the website manager wishes to be able to send mobile alerts to mobile users 106 who are subscribers of mobile service providers 108 with no reverse-billing contract or the like agreement with the application service provider. If the website manager decides to deliver mobile alerts to the mobile users 106 who are subscribers of mobile service providers 108 with no contract or the like agreement with the application service provider, the website manager is required to further decide under query No. 2 whether to pay for the charges arising as a result of sending the mobile alerts or whether the mobile users 106 be charged for receiving the mobile alerts. Further, if the website manager wants a surety of sending the mobile alerts to mobile users 106 who are subscribers of mobile service providers 108 with no reverse-billing contract or the like agreement with the application service provider, including those mobile users 106 who are unwilling to bear the cost of receiving the mobile alerts, the website managers can then elect to pay for the sent mobile alerts. The website manager is then required to furnish credit card details, financial information or provide details on other modes of payment under payment details.

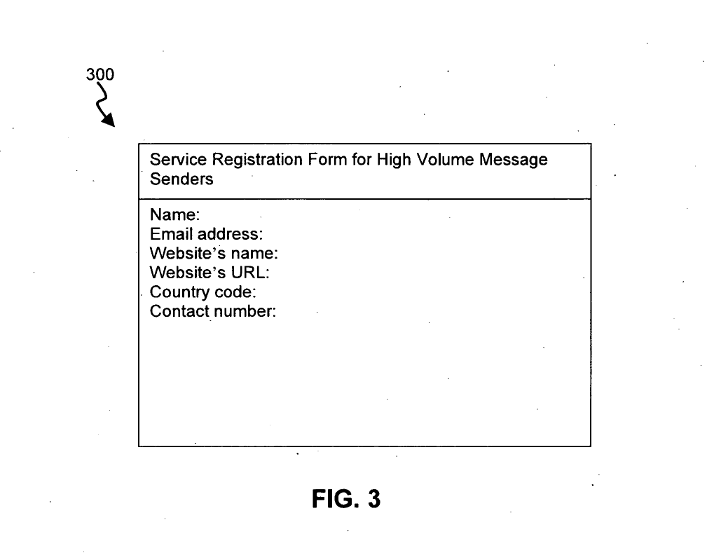

Similarly, FIG. 3 then depicts a service registration form for high volume message senders 300 (hereinafter referred to as high-volume form) in a graphical format defining entry fields of the high-volume form 300. The high-volume form 300 contains entry fields for defining a website manager's name, a website manager's email address, a website's name, a website's URL, a country code, and a contact number. The definitions for the entry fields of the high-volume form 300 are similar in definitions for the respective similar entry fields of the low-volume form 200 as shown in FIG. 2.

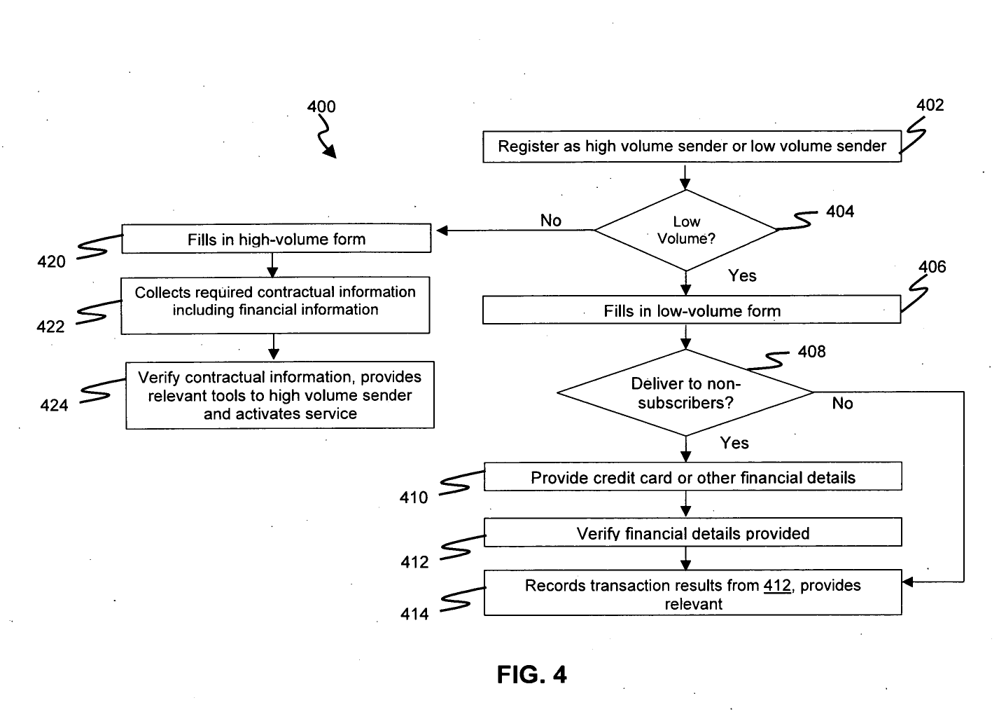

A process flowchart 400 wherein the website manager signs up with the application service provider for sending mobile alerts to mobile users 106 is shown in FIG. 4. In a step 402, the website manager accepts the terms and conditions imposed by the application service provider for the usage of the event update management system 100. The website manager is required to decide whether to register as a low volume message sender or a high volume message sender, wherein a decision is then made in a step 404.

Low volume message senders preferably have a requirement of sending less than 1000 messages per month. With low volume message senders, the registration and activation process should preferably be completely automated, without requiring any human intervention from the application service provider. This is because the application service provider preferably should have predetermined that the business risk associated with immediate activation posed, for example, through spammers or scam messengers, is justifiable given that the application service provider does not incur any additional cost through the activation of the mobile alert service to the low volume senders. Additionally, the application service provider is likely instead to receive payments from the mobile service providers whose subscribers receive the mobile alerts. Further, in order to mitigate business risk, the application service provider may also impose additional restrictions on the low volume message senders, for example limiting any combination of the maximum number of messages the low volume message sender is allowed to send in a given period or to a mobile user 106. The application service provider should also preferably assume that the low volume message sender possesses limited technical skills or limited technical resources or otherwise is unwilling or unable to invest in close systems integration. An example of such a low volume message sender is a blogger who wishes to offer the blog readers, update alerts through mobile phones but lacks the technical wherewithal to perform systems integration. For the low volume message sender, the application service provider preferably should make available an automatically generated block of HTML link codes that the low volume message sender can easily integrate together with the webpages of the website through which the mobile alert service is to be made available to the website visitors, allowing for easy implementation. Further, the application service provider preferably also can make available pictorial guides on how to perform the HTML link codes integration for example indicating where to insert the HTML link codes in the webpage.

High volume message senders on the other hand preferably have a requirement of sending more than 1000 messages per month, some with possible requirements of sending more than 1000 messages per hour. With high volume message senders, the application service provider may preferably decide to invest in the time and effort needed for validation of certain factors such as the identity of the high volume message sender, nature of business, company registration information, financial securities or other such risk mitigation factors in order to manage the business risk. In return for the validation conducted, the application service provider may also impose few or no or different restrictions on the high volume message sender. In addition, it is also assumed that the high volume message sender has the technical resources, and the interest and the wherewithal to enable tighter integration of the website with the application service provider's system, thus providing the high volume message sender with higher levels of customization and automation. A non-limiting example of the high volume message sender is an online auction site or an online free email service that caters to millions of web users. The website manager is not required to negotiate a message sending contract with the mobile service providers 108 in the example although electronic or paper template contract documentations preferably may be required by the mobile service providers 108. Further, no human intervention is required from the mobile service providers 108 prior to the activation of message sending services offered to the website manager.

The website manager then fills in the low-volume form 200 in a step 406 if the website manager decides to sign up as a low volume message sender. In a step 408, the website manager needs to decide whether to be able to send mobile alerts to mobile users 106 who are subscribers of mobile service providers 108 who do not have a reverse-charge agreement with the application service provider. Normally, under the mentioned scenario, the application service provider is charged by the mobile service provider 108, who is the first party to receive the mobile alerts destined for the mobile users 106, for sending the mobile alerts to the mobile users 106. Thus, the application service provider may preferably wish to recover the charges incurred, and possibly a mark-up thereon, from either the low volume message sender or the mobile users 106 who have signed up to receive the mobile alerts from the low volume message sender.

If the website manager decides to have the flexibility of delivering the mobile alerts to mobile users 106 who are not subscribers to mobile service providers 108 who are in a reverse-billing contract arrangement or the like arrangement with the application service provider, the application service provider then requests that the low volume message sender place a financial deposit, furnish verifiable credit card details or provide other forms of financial security in step a 410, thereby allowing the application service provider to recover the charges due. In a step 412, the application service provider verifies the validity of the financial information provided by the website manager in the step 410 and charges a pre-agreed, specified amount of money to the website manager's credit card or performs a direct debit from the website manager's bank account or otherwise engages in a financial transaction pre-agreed mutually between the website manager and the application service provider. The terms and conditions have been agreed to by the website manager in the steps 402 and 410, and determines to what extent the mobile alerts as delivered are not covered by the reverse-billing contracts or the like agreements.

Finally, in a step 414, the application service provider records transaction results that occurred in the step 412. The transaction results preferably include whether the website manager is permitted to send the mobile alerts to mobile users 106 who are subscribers of mobile service providers 108 with no reverse-billing contracts or the like agreements with the application service provider, the rightful parties then to be charged for the mobile alerts, the registration information of the low-volume form 200. Subsequently, the application service provider then provides the website manager with information such as the HTML link codes, login ID, password, and any other documentation that the website manager preferably needs in order to use the message sending services. The information is preferably provided by any feasible means using e-mails, immediately on-screen, registered mail and the like. The application service provider then immediately activates the message sending services for the low volume message sender.

The website manager fills in the high-volume form 300 in a step 420 if the website manager determines that the required needs fit in as a high volume message sender. As the application service provider have determined that the high volume message senders require human verification, an authorized representative of the application service provider then liaises with the website manager in a step 422. The application service provider determines the needs of the website manager, obtain the information required by the application service provider, and fulfills any other paperwork requirements in the step 422. Finally, in a step 424, the application service provider verifies all relevant data obtained from the high volume message sender. When all the required internal business needs are fulfilled, the application service provider provides the website manager with the relevant APIs, codes, documentation, user ID, password, and any other information and tools that the website manager preferably needs in order to using the message sending services. Further, in the step 424, the application service provider stores all relevant information, credentials and documentations pertaining to the high volume message sender and activates the service for the high volume message sender.

The application service provider can further include under the process flowchart 400 a verification process (not shown) of the website manager's identity, particularly in the case of low volume message senders where paper work is preferably not required. The verification process preferably comprises at least the steps of requesting a mobile number of the low volume message sender, sending a confirmation message to the mobile number and requiring a response from the confirmation message.

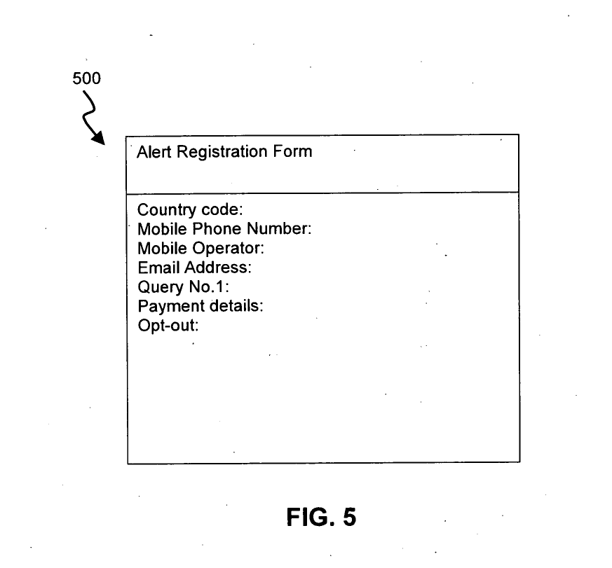

The mobile user 106 who is interested to receive updates about the websites is required to submit an alert registration request by completing an alert registration form 500 provided on the websites as depicted in FIG. 5 showing the alert registration form 500 in a graphical format defining entry fields of the alert registration form 500. However, to prevent usage abuse, the application services provider can pre-define a limit on the number of websites the mobile user 106 can register to for receiving mobile alerts. The alert registration form 500 comprises contains the entry fields for defining a country code, a mobile phone number, a query No. 1, an email address and a mobile operator. The mobile phone number defines a mobile phone number, preferably a mobile phone number belonging to the mobile user 106, for sending the mobile alerts to. In addition, to counter the problem of false sign-ups, the event-management server 102 validates the alert registration request by sending a confirmation message to the mobile phone number. The mobile user 106 then sends back a validation reply. The validation reply takes the form of a return SMS or the entry of a secret code sent in the confirmation message onto another part of the alert registration form 500 or any other form of verification that is convenient and provides the security of non-repudiation. The country code defines a country the mobile phone number is registered in which in general is the mobile user's 106 country of residence. The email address defines an email address belonging to the mobile user 106 and the mobile user 106 is also required to provide a name of the mobile services provider to which the mobile user 106 is a subscriber of under the mobile operator entry field.

Additionally, under query No. 1, the mobile user 106 decides whether to pay a possible premium rate to receive mobile alerts if the mobile service provider 108 of the mobile user 106 does not have a reverse-billing contract or the like agreement with the application service provider. The mobile user 106 is then required to furnish credit card information, place a deposit or provide details on other modes of payment with the application service provider under the payment details entry field if the mobile user 106 is agreeable to the arrangement. Lastly, in order to provide an easy way for the mobile user 106 to opt out of the mobile alert service, websites that offers the mobile alert service should preferably be required to include opt-out information under the opt-out entry field as shown in the alert registration form 500.

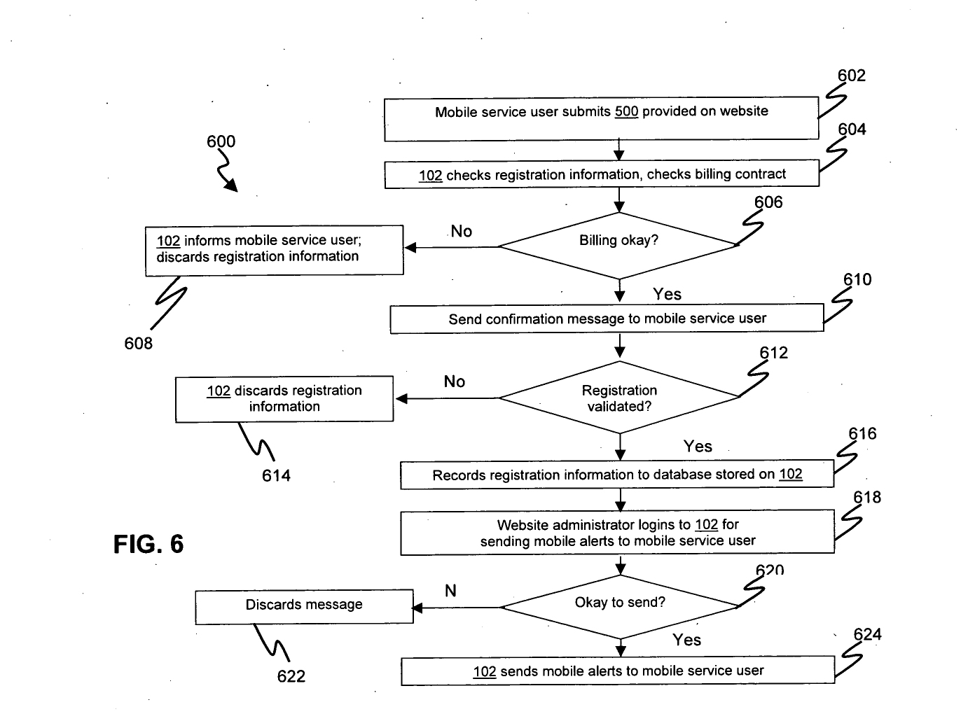

A flowchart illustrating a process wherein the mobile user 106 registers for mobile alerts for receiving updates of the website using the event management server 102 is shown in FIG. 6. The website manager operating the website is a low volume message sender. In a step 602, the mobile user 106 first fills in and submits the alert registration form 500 provided through the website. The website is preferably one which the mobile user 106 is interested on being updated on a regular basis. The alert registration form 500 is preferably hosted on the low volume message sender's website or the application service provider's website or a website that is associated with the application service provider such that alert registration information generated by filling in the alert registration form 500 can be transmitted to the event management server 102.

When the event management server 102 receives alert registration information sent by the web-host server 104, the event management server 102 checks the validity of the received alert registration information in a step 604. The event management server 102 further checks for an existing billing arrangement in a step 606 by determining the fulfillment of at least one of the following criteria: the mobile user 106 is a subscriber to one of the mobile service providers 108 with whom the application service provider has a reverse-billing contract or the like agreement or whether the website manager of web-host server 104 has indicated a willingness to send mobile alerts to mobile users 106 who are not subscribers of any of the mobile service providers 108 with whom the application service provider has a reverse-billing contract or the like agreement and whether the website manager is willing to pay the charges of the mobile alerts and whether the mobile user 106 has indicated a desire to receive mobile alerts despite not being a subscriber of one of the mobile service providers 108 with whom the application service provider has a reverse billing contract and whether the mobile user 106 has made available financial securities such as credit card information, advance deposits or has provided details on other modes of payment against which the cost of delivering the mobile alerts is to be charged. If none of the aforementioned criteria are met, the event management server 102 informs the mobile user 106 of the inability to proceed and discards the alert registration information in a step 608. The event management server 102 may then temporarily forbid the mobile number from being used for further alert registrations until the mobile service provider 108 with whom the mobile user 106 subscribes to signs a reverse-billing contract or the like agreement with the application service provider.

However, if at least one of the aforementioned criteria is met, the event management server 102 sends a confirmation message back to the mobile user 106 in a step 610. The confirmation message is preferably one of an SMS message, an MMS message or a WAP push message. The objective of sending the confirmation message is to prevent false sign-ups due to mobile or email spam registration requests. There are two types of responses the mobile user 106 preferably takes upon receipt of the confirmation message. The first type of response is that the mobile user 106 is required to take an action on receiving the confirmation message, wherein the action should preferably be clicking on a link on a page shown on a mobile device used for the alert registration or responding with an SMS or MMS or other mobile message or responding through the website itself, with a word, character, numeral or other combination thereof or any other manner as specified in the confirmation message sent to the mobile user 106. On receipt of the response, the event management server 102 proceeds to alert registration validation in a step 612. The second type of response requires the mobile user 106 not to take an action on receiving the confirmation message. The mobile user 106 does not click on a link on a page shown on the mobile device used for the alert registration or does not respond with an SMS or MMS or other mobile message or in any other manner with a word, character, numeral or combination thereof or other manner specified in the confirmation message sent to the mobile user 106. On failure to receive a response, the event management server 102 then proceeds to the alert registration validation in the step 612.

The alert registration validation serves as an important indicator of acceptance of the mobile user 106 to being charged a specified rate for receiving the mobile alerts. The charges, in general, are as low as the regular charge that the mobile user 106 incurs if the mobile user 106 is the sender of an equivalent mobile message sent locally or at the discretion of the mobile service provider 108 with whom the mobile user 106 is a subscriber, is waived or is included in a free package of mobile messages that the mobile service provider 108 makes available to the subscribers. In a worst scenario, a premium rate or specific charge is imposed on the mobile user 106 for wanting to receive mobile alerts despite the mobile service provider 108 not having a reverse-billing contract or the like agreement with the application service provider. The mobile service provider 108 is able to offer low rates for the message sending services since the mobile service provider 108 does not incur the associated significant costs for example in signing up with content partners, integrating and testing of premium billing relationships, and the like.

A determination is made in the step 612 if the alert registration is a genuine request by a holder of a mobile number used by the mobile user 106 when signing up. If the alert registration is determined to be a false sign-up resulting from mobile or email spam registration requests, the event management server 102 discards the alert registration information in a step 614. If failed alert registrations are received repeatedly for a mobile phone number, the event management server 102 may then temporarily forbids the mobile phone number from being used for further alert registrations for a pre-defined time period. The ban is executed when a pre-defined number of failed alert registrations in which a mobile phone number can be used for registering mobile alerts are exceeded. The pre-defined time period for lifting the ban is preferably programmed for example, to be 24 hours. However, if the alert registration is determined to be genuine, the event management server 102 then records the received alert registration information together with the data and time of registration onto the database residing in the event management server 102 in a step 616. Therefore, the alert registration is considered non-repudiative.

When updates are available from the website, the website manager then logs into the event management server 102 in a step 618 for instructing the event management server 102 to send the mobile alerts to the mobile users 106. The website manager preferably is allowed to select the recipients the mobile alerts are to be delivered to, if a plurality of mobile users 106 have registered to receive the website updates by, for example, manually entering the mobile numbers of the recipients or uploading the numbers of the recipients in a file. The website manager preferably is also allowed to select the message for sending to send to one or all of the recipients to who the website manager wants the mobile alert to be delivered.

In a step 620, the event management server 102 then checks if all the criteria for sending the mobile alerts to the mobile users 106 are satisfied before sending the mobile alerts. The criteria are listed accordingly. Verification is conducted on each of the mobile users 106 as selected by the website manager to have actually registered to receive mobile alerts from the particular website. In addition, the mobile service provider 108 that the mobile user 106 subscribes to preferably has already signed a reverse-billing contract or the like agreement with the application service provider. If otherwise, the website manager preferably has indicated a willingness to pay for the sending of the mobile alerts during the message sending service registration or the mobile user 106 has indicated willingness to pay to receive the mobile alerts during the mobile alert registration. Further, a check is also conducted on a number of other rules which preferably include rules that limit the number of mobile alerts the website is allowed to send in a particular period or to a particular mobile user 106, or a combination thereof. Lastly, a verification is preferably conducted to ensure that the mobile users 106 to whom the mobile alerts are to be delivered to, have not placed any restrictions on the message sender that results in a specific message being disallowed and any other rules that may be implemented in the interest of providing a quality service to the mobile users 106 and the website manager.

If any of the aforementioned criteria are not met or verification fails, the specific message for the mobile user 106 is discarded in a step 622. However, if all the aforementioned criteria are met, the event management server 102 then sends the mobile alerts to the mobile user 106 in a step 624, wherein the mobile alerts are being sent via the appropriate mobile service provider 108 as pre-defined for the mobile user 106 by the application service provider. Additionally, regardless of whether the aforementioned criteria are met or not, the event management server 102 preferably records the nature of the mobile alert, the mobile alert, a sending status, a delivery status, and any other information relevant to the mobile alert in a database stored on the event management server 102. The database may subsequently be made accessible to the website manager.

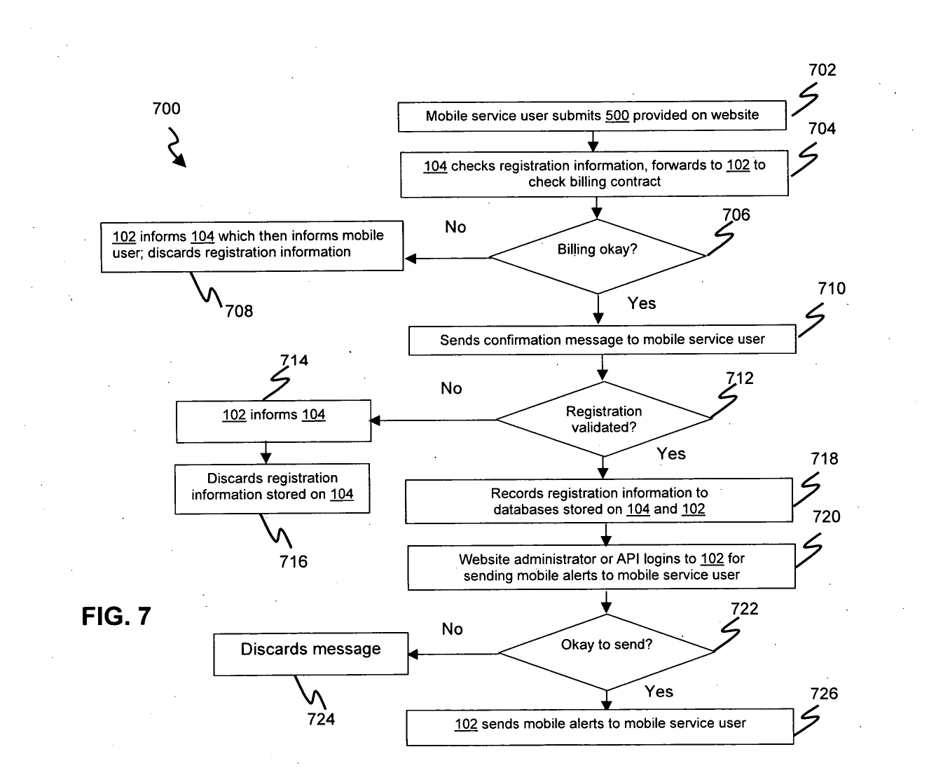

Similarly, FIG. 7 shows a flowchart illustrating a process wherein the mobile user 106 registers for mobile alerts for receiving updates of the website using the event management server 102. The website manager operating the website is a high volume message sender. For a high volume message sender, the website needs to be pre-programmed with the supplied set of API structures and be integrated with the software libraries. As such, the high volume message sender is able to highly customize the mobile alerts sent to the mobile user 106 as compared to the low volume message sender who can only use the substantially fixed format as defined by the application services provider. In a step 702, the mobile user 106 fills in and submits the alert registration form 500 provided on the website. The website is preferably one which the mobile user 106 is interested on being updated on a regular basis. The alert registration form 500 is preferably hosted on the web-host server 104 since the alert registration form 500 is highly customized to suit the requirements of the web-host server 104.

In a step 704, the web-host server 104 checks if the alert registration form 500 is appropriately filled in, stores a copy on the web-host server 104 and forwards the alert registration information to the event management server 102 for checking the billing and alert registration validity as the billing information and message sending abilities reside only with the event management server 102. The event management server 102 then checks for an existing billing arrangement by checking for the fulfillment of at least one of the criteria listed accordingly in a step 706: the mobile user 106 is a subscriber to one of the mobile service providers 108 with whom the application service provider has a reverse-billing contract or the like agreement or whether the website manager of web-host server 104 has indicated a willingness to send mobile alerts to mobile users 106 who are not subscribers of any of the mobile service providers 108 with whom the application service provider has a reverse-billing contract or the like agreement and whether the aforementioned website manager is willing to pay the charges for the sending of the mobile alerts and whether the mobile user 106 has indicated a desire to receive the mobile alerts despite not being a subscriber of one of the mobile service providers 108 with whom the application service provider has a reverse billing contract and whether the mobile user 106 has made available financial securities such as credit card information, advance deposits or provided details on other modes of payment against which the cost of delivering the mobile alert is to be charged.

If none of the aforementioned criteria are met, the event management server 102 informs the web-host server 104 of the billing condition failure in a step 708. The web-host server 104 then informs the mobile user 106 of the inability to proceed and discards the alert registration information in the step 708. The web-host server 104 as well as the event management server 102 preferably also temporarily forbids the mobile number from being used for further alert registrations until the mobile service provider 108 with whom the mobile user 106 subscribes to signs a reverse-billing contract or the like agreement with the application service provider. However, if at least one of the aforementioned criteria is met, the event management server 102 sends a confirmation message back to the mobile user 106 in a step 710. The confirmation message is preferably one of an SMS message, an MMS message or a WAP push message. The objective of sending the confirmation message is to prevent false sign-ups due to mobile or email spam registration requests. There are two types of responses the mobile user 106 preferably takes upon receipt of the confirmation message. The first type of response is that the mobile user 106 is required to take an action on receiving the confirmation message, wherein the action should preferably be clicking on a link on a page shown on a mobile device used for the alert registration or responding with an SMS or MMS or other mobile message or responding through the website itself, with a word, character, numeral or other combination thereof or any other manner as specified in the confirmation message sent to the mobile user 106. On receipt of the response, the event management server 102 proceeds to alert registration validation in a step 712. The second type of response requires the mobile user 106 not to take an action on receiving the confirmation message. The mobile user 106 does not click on a link on a page shown on the mobile device used for the alert registration or does not respond with an SMS or MMS or other mobile message or in any other manner with a word, character, numeral or combination thereof or other manner specified in the confirmation message sent to the mobile user 106. On failure to receive a response, the event management server 102 then proceeds to the alert registration validation in the step 712.

The alert registration validation serves as an important indicator of acceptance of the mobile user 106 to being charged a specified rate for receiving the mobile alerts. The charges, in general, are as low as the regular charge that the mobile user 106 incurs if the mobile user 106 is the sender of an equivalent mobile message sent locally or at the discretion of the mobile service provider 108 with whom the mobile user 106 is a subscriber, is waived or is included in a free package of mobile messages that the mobile service provider 108 makes available to the subscribers. In the worst scenario, a premium rate or specific charge is imposed on the mobile user 106 for wanting to receive mobile alerts despite the mobile service provider 108 not having a reverse-billing contract or the like agreement with the application service provider. The mobile service provider 108 is able to offer low rates for the message sending services since the mobile service provider 108 does not incur the associated significant costs for example in signing up with content partners, integrating and testing of premium billing relationships, and the like.

A decision is then taken in a step 712 in determining if the alert registration is a genuine request by a holder of the mobile number used by mobile user 106 when signing up. If the alert registration is determined to be a false sign-up resulting from mobile or email spam registration requests, the event management server 102 relays the information back to the web-host server 104 in a step 714. The web-host server 104 then discards the received alert registration information in a step 716. If failed alert registrations are received repeatedly for a mobile phone number, the event management server 102 and the web-host server 104 may then temporarily forbid the mobile phone number from being used for further alert registrations for a pre-defined time period. The ban is executed when a pre-defined number of failed registration attempts in which the mobile phone number can be used for registering mobile alerts are exceeded. The pre-defined time period for lifting the ban is preferably programmed for example, to be 24 hours. However, if the alert registration is determined to be genuine, the event management server 102 then, in a step 718, records the received alert registration information together with the data and time of registration onto the database stored in both the event management server 102 and the web-host server 104. Preferably, the information is also made available to the web-host server 104 for enabling the web-host server 104 to manage the alert registration information as appropriate to business rules used by the web-host server 104. The alert registration is considered non-repudiative.

When updates are available from the website, the website manager logs into the event management server 102 in a step 720 for instructing the event management server 102 to send mobile alerts to the mobile user 106. In general, for a high volume message sender, the website manager is allowed to select the recipients to who the mobile alerts are to be delivered, if a plurality of mobile users 106 have registered to receive the website updates. Alternatively, a software program running on the web-host server 104 uses the APIs or other codes provided by the application service provider to automatically login to the event management server 102. The software program then instructs the event management server 102 to send mobile alerts to the relevant mobile users 106.

Before sending the mobile alerts, the event management server 102 checks if all the criteria for sending the mobile alerts to the mobile users 106 are satisfied in a step 722. The criteria are listed accordingly. Verification is conducted on each of the mobile users 106 as selected by the website manager or the API or similar code have actually registered to receive mobile alerts from the particular website. In addition, the mobile service provider that the mobile user 106 subscribes to preferably has signed a reverse-billing contract or the like agreement with the application service provider. If otherwise, the website manager preferably has indicated willingness to pay for the sending of the mobile alerts in the paper-work or otherwise during the message sending service registration or the mobile user 106 has indicated willingness to pay to receive the mobile alerts during the mobile alert registration. Further, a check is also conducted on a number of other rules which preferably include rules that limit the number of mobile alerts the website is allowed to send in a particular period or to a particular mobile user 106, or a combination thereof. Lastly, a verification is preferably conducted to ensure that the mobile users 106, to whom the mobile alerts are to be delivered, have not placed any restrictions on the message sender that results in a specific message being disallowed and any other rules that may be implemented in the interest of providing a quality service to the mobile users 106 and the website manager.

If any of the aforementioned criteria are not met or verification fails, the specific message for the mobile user 106 is discarded in a step 724. However, if all the aforementioned criteria are met, the event management server 102 then sends the mobile alerts to the mobile user 106 in a step 726, wherein the mobile alerts are being sent via the appropriate mobile service provider 108 as pre-defined for the mobile user 106 by the application service provider. Additionally, regardless of whether the aforementioned criteria are met or not, the event management server 102 preferably records the nature of the mobile alert, the mobile alert, a sending status, a delivery status, and any other information relevant to the mobile alert in a database stored on the event management server 102. The database may subsequently be made accessible to the website manager.

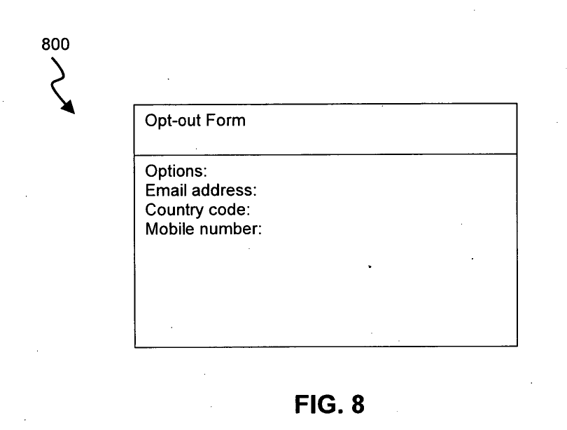

Enabling the mobile user 106 to opt out of receiving further mobile alerts is an important element of the event update management system 100. FIG. 8 shows an opt-out form 800 in a graphical format defining entry fields of the opt-out form 800. In the opt-out form 800, the mobile user 106 is given the options under an options entry field for restricting any web-host servers 104 from temporarily or permanently sending the mobile user 106 further mobile alerts, where the mobile user 106 has previously registered for mobile alerts from the respective relevant web-host servers 104. In general, the alert registration form 500 is required to carry a link to the opt-out form 800, thus enabling the mobile user 106 to easily find the opt-out information. In the opt-out form 800, the mobile user 106 is required provide a mobile number information including indicating a country code for the mobile service the mobile user 106 uses is registered in and a mobile number used for the mobile alert registrations. The event management server 102 then uses the mobile number information to determine whether the mobile user 106 has previously registered to receive mobile alerts from the specified web-host servers 104 and further uses the mobile number information to validate the opt-out request. In addition, the mobile user 106 is also required to provide an email address to which the status of an opt-out request is sent on the conclusion of the opt-out process.

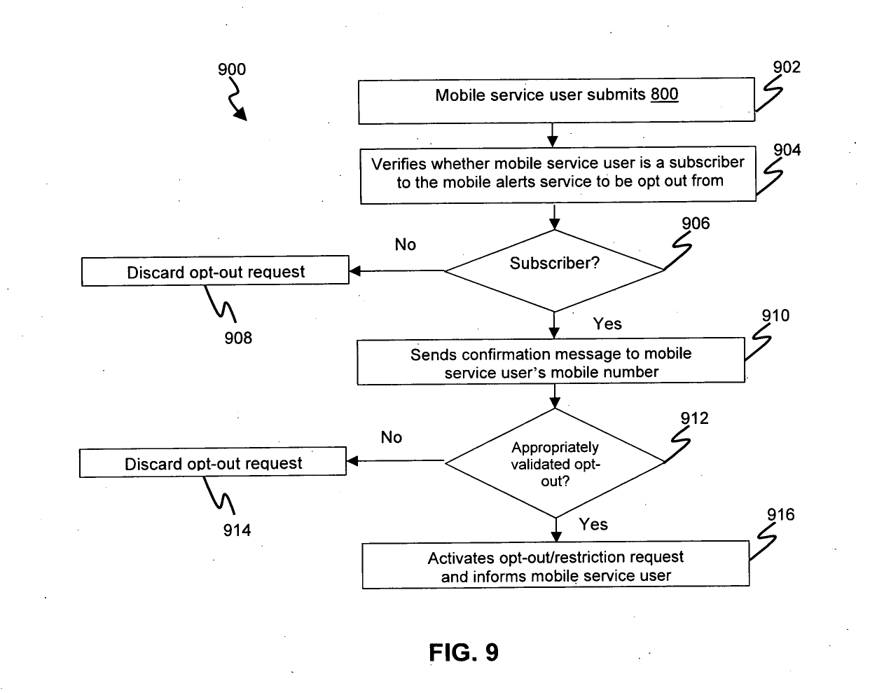

FIG. 9. illustrates a flowchart of an opt-out process 900 wherein in a step 902, the mobile user 106 submits the opt-out form 800 via any web-host servers 104 that offers mobile alerts through the event management server 102 or directly by visiting the website of the application service provider, which preferably is also the website of the event management server 102. In a step 904, the application service provider then verifies whether the mobile number provided by the mobile user 106 is previously registered to receive mobile alerts from a web-host server 104 that the mobile user 106 wants to restrict or temporarily or permanently forbid from sending the mobile user 106 further mobile alerts. A determination is made in a step 906. If it is determined that the mobile user 106 is not registered to receive mobile alerts from the specified web-host server 104, the event management server 102 informs the mobile user 106, preferably via a web form response page, that the mobile user 106 is not registered to receive mobile alerts from the specified web-host server 104. The event management server 102 then discards the opt-out request subsequently in a step 908. However, if it is determined that the mobile user 106 is registered to receive mobile alerts from the specified web-host server 104, the event management server 102 then validates that the mobile user 106 requesting for the opt-out is indeed the holder of the mobile number that the mobile user 106 has specified in the opt-out form 800. The aforementioned required validation is important to prevent fraudulent or mischievous termination of services to a legitimate mobile user 106.

In order to validate the identity of the mobile user 106, the event management server 102 sends a confirmation message to the mobile number indicated by the mobile user 106 in the opt-out form 800 in a step 910. The validation process is similar to the steps 610 through 616 shown in FIG. 6. In a step 912, the event management server 102 determines whether the opt-out request is valid. If the opt-out request is invalid, the opt-out request is discarded in a step 914 and the mobile user 106 is informed, preferably via the email address provided by the mobile user 106 in the opt-out form 800. To inform the mobile user 106 of the status on a web-page shown as a response when the mobile user 106 initially submits the opt-out form 800 is considered impractical due to the duration involved in the opt-out process. However, if the opt-out request is valid, the opt-out request is then recorded onto the databases of the event management server 102. In a final step 916, the opt-out request is immediately activated, and the mobile user 106 is informed of the successful opt-out or service restriction via the email address provided by the mobile user 106 in the opt-out form 800. To inform the mobile user 106 of the status on a web-page shown as a response when the mobile user 106 initially submits the opt-out form 800 is considered impractical due to the duration involved in the opt-out process. The event management server 102 should preferably also send an electronic notification to the relevant web-host server 104 of the opt-out or service restriction warranted by the mobile user 106.

In the foregoing manner, an event update management system for providing updates and event notifications to mobile users who have registered for mobile alerts to receive website updates is described according to an embodiment of the disclosure for addressing the foregoing disadvantages of current event update management approaches pertaining to the delivery of mobile alerts. Although only one embodiment of the disclosure is disclosed, it will be apparent to one skilled in the art in view of this disclosure that numerous changes and/or modification can be made without departing from the scope and spirit of the disclosure.

What is claimed is:

1. An event update management system comprising:
a) a data module for receiving alert registration data provided by a web-host server, the alert registration data being generated when a mobile service user submits an alert registration request corresponding to an event through the web-host server;
b) a database for storing the alert registration data; and
c) an alert module for generating an alert in response to an instruction provided by a website manager operating the web-host server, the instruction being associated with the event and the alert module further for sending the alert to the mobile service user corresponding with the alert registration data.

2. The event update management system as in claim 1, further comprising a validation module for sending a message to the mobile service user for validating the alert registration request submitted by the mobile service user through the web-host server, the message being the alert.

3. The event update management system as in claim 1, wherein the alert is selected from the group consisting of a Short Message Service message, a Multimedia Message Service message, and a Wireless Application Protocol push message.

4. The event update management system as in claim 1, the web-host server for hosting a website being pre-programmed with one of a set of said Application Programming Interface functions and source codes provided by the event update management system.

5. The event update management system as in claim 4, the set of said Application Programming Interface functions define software intercommunication functions for use with the website for communicating with the event update management system.

6. The event update management system as in claim 1, wherein the web-host server pre-downloads and pre-integrates software libraries with the website, the software libraries being provided by the event update management system.

7. The event update management system as in claim 6, the software libraries being software implementations of the set of said Application Programming Interface functions.

8. The event update management system as in claim 4, the website providing an alert registration form for use with the alert registration request.

9. The event update management system as in claim 8, the alert registration form comprising entry fields for capturing at least one of registration details and billing details of the mobile service user for generating the alert registration data therefrom.

10. The event update management system as in claim 1, the alert module further for tracking at least one of the alert sent to the mobile service user.

11. The event update management system as in claim 1, further comprising:
a plurality of accounts, one of the plurality of accounts corresponding to the website manager operating the web-host server for providing at least one of administrative functions related to the one of the plurality of accounts and to enable the website manager to instruct the alert module for generating and sending the alert to the mobile service user.

12. The event update management system as in claim 1, further comprising:
a billing module for managing billing details of at least one of the mobile service user and the web-host server, the billing details corresponding with the alert sent to the mobile service user by the alert module.

13. The event update management system as in claim 1, the alert registration data being accessible and editable by one of the mobile service user and the web-host server.

14. An event update management method comprising the steps of:
receiving alert registration data provided by a web-host server by a data module, the alert registration data being generated when a mobile service user submits an alert registration request corresponding to an event through the web-host server;
recording the alert registration data to a database;
generating an alert in response to an instruction being received from the web-host server, the instruction being associated with the event; and
sending the alert to the mobile service user corresponding with the alert registration data.

15. The event update management method as in claim 14, further comprising the step of providing a validation module for sending a message to the mobile service user for validating the alert registration request submitted by the mobile service user through the web-host server, the message being the alert.

16. The event update management method as in claim 14, the step of sending the alert comprising the step of:
generating and sending a message selected from the group consisting of a Short Message Service message, a Multimedia Message Service message, and a Wireless Application Protocol push message as the alert.

17. The event update management method as in claim 14, further comprising the step of hosting a website by the web-host server, the website being pre-programmed with one of a set of Application Programming Interface functions and source codes provided by the event update management system.

18. The event update management method as in claim 17, the step of hosting a website by the web-host server comprising the step of:
providing said set of said Application Programming Interface functions defining software intercommunication functions for use with the website for communicating with the event update management system.

19. The event update management method as in claim 17, the step of hosting a website by the web-host server comprising the step of providing software libraries by the event update management system.

20. The event update management method as in claim 19, the software libraries being implementations of the set of said Application Programming Interface functions in software.

21. The event update management method as in claim 17, the step of hosting a website by the web-host server comprising providing an alert registration form by the website for use with the alert registration request.

22. The event update management method as in claim 21, the step of providing the alert registration form, comprising:
providing the alert registration form comprising entry fields for capturing at least one of registration details and billing details of the mobile service user for generating the alert registration data therefrom.

23. The event update management method as in claim 14, the step of sending the alert comprising tracking at least one of the alerts sent to the mobile service user.

24. The event update management method as in claim 14, further comprising:
providing a plurality of accounts, one of the plurality of accounts corresponding to the website manager operating the web-host server for providing at least one of administrative functions related to the one of the plurality of accounts and to enable the website manager to instruct the alert module for generating and sending the alert to the mobile service user.

25. The event update management method as in claim 14, further comprising:
managing billing details of at least one of the mobile service user and the web-host server, the billing details corresponding with the alert sent to the mobile service user by the alert module.

26. The event update management method as in claim 14, further comprising:
permitting access to the alert registration data by one of the mobile service user and the web-host server for editing the alert registration data.

27. A machine readable medium having stored therein a plurality of programming instructions which when executed, cause the machine to:
a) receive alert registration data provided by a web-host server by a data module, the alert registration data being generated when a mobile service user submits an alert registration request corresponding to an event through the web-host server;
b) record the alert registration data to a database;
c) generate an alert in response to an instruction being received from the web-host server, the instruction being associated with the event; and
d) send the alert to the mobile service user corresponding with the alert registration data.

28. The machine readable medium as in claim 27, wherein the programming instructions, when executed, cause the machine to further provide a validation module for sending a message to the mobile service user for validating the alert registration request submitted by the mobile service user through the web-host server, the message being the alert.

29. The machine readable medium as in claim 27, wherein the programming instructions, when executed, cause the machine to generate and send one of a Short Message Service message, a Multimedia Message Service message, and a Wireless Application Protocol push message as the alert.

30. The machine readable medium as in claim 27, wherein the programming instructions, when executed, cause the machine to further require hosting a website by the web-host server, the website being pre-programmed with one of a set of Application Programming Interface functions and source codes provided by the event update management system.

31. The machine readable medium as in claim 30, wherein the programming instructions, which when executed, cause the machine to provide said set of said Application Programming Interface functions defining software intercommunication functions for use with the website for communicating with the event update management system.

32. The machine readable medium as in claim 30, wherein the programming instructions, when executed, cause the machine to provide software libraries by the event update management system.

33. The machine readable medium as in claim 32, wherein the programming instructions, when executed, cause the machine to require the software libraries being implementations of the set of said Application Programming Interface functions in software.

34. The machine readable medium as in claim 30, wherein the programming instructions, when executed, cause the machine to provide an alert registration form by the website for use with the alert registration request.

35. The machine readable medium as in claim 34, wherein the programming instructions, when executed, cause the machine to provide the alert registration form comprising entry fields for capturing at least one of registration details and billing details of the mobile service user for generating the alert registration data therefrom.

36. The machine readable medium as in claim 27, wherein the programming instructions, when executed, cause the machine to track at least one of the alerts sent to the mobile service user.

37. The machine readable medium as in claim 27, wherein the programming instructions, which when executed, cause the machine to further provide a plurality of accounts, one of the plurality of accounts corresponding to the website manager operating the web-host server for providing at least one of administrative functions related to the one of the plurality of accounts and to enable the website manager to instruct the alert module for generating and sending the alert to the mobile service user.

38. The machine readable medium as in claim 27, wherein the programming instructions, which when executed, cause the machine to manage billing details of at least one of the mobile service user and the web-host server, the billing details corresponding with the alert sent to the mobile service user by the alert module.

39. The machine readable medium as in claim 30, wherein the programming instructions, which when executed, cause the machine to permit access to the alert registration data by one of the mobile service user and the web-host server for editing the alert registration data.
